(19) United States
(12) Patent Application Publication
(10) Pub. No.: US 2012/0049419 A1
(43) Pub. Date: Mar. 1, 2012

(54) Process And Apparatus For Manufacturing Ceramic Honeycombs

(76) Inventors: Paul Michael Eicher, Dublin, VA (US); Sandra Lee Gray, Horseheads, NY (US); Peter John Hynes, Addison, NY (US); Daniel Edward McCauley, Watkins Glen, NY (US); Jeffrey S. White, Corning, NY (US)

(21) Appl. No.: 12/872,136

(22) Filed: Aug. 31, 2010

(51) Int. Cl. B28B 3/26; C04B 35/622; B28B 17/02; C04B 35/03

(52) U.S. Cl. 264/630; 425/204

(57) ABSTRACT

Methods and apparatus for making ceramic honeycombs by steps including compounding a plasticized ceramic batch mixture and forming the mixture into ceramic honeycombs by continuous extrusion, drying and firing, wherein one or more ceramic powders for the batch mixture are supplied by in-line homogenization as a powder feed having a median particle size D₅₀ that varies from a maximum value to a minimum value by an amount not exceeding 15% of the maximum value during a 24-hour period of continuous extrusion.

### BACKGROUND

1. Field of the Disclosure

The present disclosure relates generally to the manufacture of ceramic products and more particularly to the manufacture of ceramic honeycomb structures useful, for example, for the manufacture of ceramic catalyst supports and ceramic wall flow particulate filters. Ceramic catalyst supports and filters are widely used to remove pollutants from the exhaust gases produced by motor vehicles, power plants, and other sources of carbon combustion pollution.

2. Technical Background

The manufacturers of systems for the control of atmospheric pollutants such as carbon monoxide, unburned hydrocarbons, and carbonaceous particulates produced by carbon and hydrocarbon combustion processes presently rely on ceramic catalyst supports and filters of closely controlled physical properties to perform the essential functions of those systems. The designs of such systems are in fact dictated largely by the thermal expansions, porosities, geometries, and physical strengths that are attainable in presently available refractory ceramic materials. Commercially important examples of such materials include cordierite, aluminum titanate, and silicon carbide, these being capable of providing ceramic honeycombs of controlled porosity and high strength and refractoriness.

The ceramic honeycombs used for these purposes are generally produced by the extrusion of plasticized mixtures of ceramic precursors to form green honeycomb extrudate that is then dried and fired (reaction-sintered) to provide honeycomb shapes of controlled porosity and size. The ability to manufacture extrude-to-shape ceramic honeycombs is dependent on the ability of honeycomb manufacturers to minimize the variability in how much the extruded honeycomb extrudate shrinks (or grows), and how the pore structure of the ceramic is developed, during the drying and firing stages of honeycomb production.

With the adoption of increasingly strict pollution control regulations and the resulting demand for more advanced anti-pollution system designs and performance, system manufacturers are requiring improved consistency in the physical properties of the ceramic honeycombs incorporated in such systems. As a specific example, the need for improved consistency has resulted in a need for tightened specifications relating to the external sizes and shapes of the honeycombs. Meeting existing tolerances for circumferential size and shape in cylindrical honeycomb products presently requires that the expected natural dimensional changes resulting from the firing of those products remain within ±0.3% of the expected or targeted dimensional changes. Future requirements that will impose a requirement for control to within ±0.2% of targeted dimensional changes are anticipated. Depending on the sizes and shapes of the products to be manufactured, such a future requirement could result in more than a ten-fold increase in production losses due to out-of-tolerance ware.

Existing methods for controlling dimensional changes during the drying and reaction-sintering of refractory ceramics such as cordierite and aluminum titanate are ineffective and/or uneconomic. Tight control over the compositions and particle sizes of the ceramic precursor raw materials used for honeycomb production can be helpful, but is uneconomic because many of these raw materials are mined powders that are inconsistent in chemical composition and particle size. Supplemental processing to improve or select from these powders is cost-prohibitive. Ceramic batch additives that can change the levels of shrinkage occurring during reaction sintering are known, but are not an effective solution where the shrinkage properties of the major components of the honeycomb batch are inconsistent.

Accordingly there remains a need for advancements in ceramic honeycomb production that can reduce variability in the sizes and other properties of the honeycombs without unacceptably increasing productions costs or decreasing production rates.

### SUMMARY

The methods and apparatus provided in accordance with the present disclosure do not require the use of special batch additives or the extensive pre-processing of raw materials for the manufacture of ceramic honeycombs. Substantial reductions in product variability are instead achieved using conventional batch materials, and without requiring extensive modifications to manufacturing equipment or process flows.

The disclosed methods and apparatus, based generally on the in-line homogenization of selected batch materials that strongly influence honeycomb properties, are broadly applicable to the manufacture of ceramic honeycomb bodies by the known steps of batch preparation, extrusion, drying, and firing. A plasticized ceramic powder batch comprising a liquid vehicle and a mixture of powdered oxides or oxide precursors is first compounded, the plasticized batch is then formed into green honeycomb extrudate by continuous extrusion, and the honeycomb extrudate is then dried and fired to produce a ceramic honeycomb body. In accordance with the present disclosure, however, the step of compounding includes a step of delivering at least one oxide or oxide precursor powder of a selected median particle size to a mixer for incorporation into the ceramic batch mixture, while homogenizing the delivered powder to insure that the median particle size varies from a maximum value to a minimum value by an amount not exceeding 15% of the maximum value during a 24-hour period of continuous extrusion.

The disclosed methods can be applied to the delivery of any of the known powdered batch materials for incorporation into a plasticized ceramic powder batch, but are particularly advantageous where the powders normally procured for manufacture have a broad particle size distribution and/or exhibit significant variations in median particle size as delivered from raw materials suppliers, and where those particles sizes or size distributions strongly affect the firing shrinkage or other properties of the fired honeycombs. Powders selected from the group consisting of aluminum oxide and graphite (graphitic carbon) are particular examples of such powders.

In particular embodiments, the disclosure provides a method for making a ceramic honeycomb from a continuous feed of plasticized honeycomb batch material, the batch material comprising a powder mixture of honeycomb precursors including at least one powder selected from the group of aluminum oxide and graphite powders, wherein the median particle size of the at least one powder varies from a maximum value to a minimum value by an amount not exceeding 10% of the maximum value during a 24-hour interval of continuous feed.

Also provided in accordance with the present disclosure are improved systems for manufacturing ceramic honeycombs. Included systems are those comprising a dry powder blender, a wet batch mixer downstream of the blender, and a continuous extruder downstream of the wet mixer for plasticizing and conveying a plasticized wet mixture of ceramic precursor powders and a vehicle through a honeycomb extrusion die. In accordance with the present disclosure, at least one of the ceramic powder precursors is delivered to the dry powder blender from a bulk powder reservoir, with the bulk powder reservoir incorporating means for homogenizing a feed of the at least one dry powder prior to delivery of the feed to the dry powder blender. Particular embodiments facilitated through the use of the disclosed systems are those wherein the least one dry powder thus delivered to the dry powder blender is selected from the group of aluminum oxide and graphite.

### BRIEF DESCRIPTION OF THE DRAWINGS

The disclosed methods and apparatus are further described below with reference to the appended drawings, wherein:

FIG. 1 is a plot tracking honeycomb shrinkage and median alumina particle size over a time interval of honeycomb production;

FIG. 2 is a schematic diagram of a honeycomb manufacturing system;

FIG. 3 is a schematic illustration of apparatus for in-line ceramic powder homogenization; and

FIG. 4 is graph plotting the particles size distributions of powdered alumina honeycomb batch constituents.

### DETAILED DESCRIPTION

While the presently disclosed methods and apparatus are useful for minimizing manufacturing variances in essentially any ceramic manufacturing process where undesirably large departures from target properties can occur during drying or firing of green preforms, particular advantages can be secured for the production of technical ceramics such as ceramic honeycombs that have tight manufacturing tolerances for product size, porosity and strength. Accordingly, the following descriptions and illustrations of specific embodiments of those methods make frequent reference to systems and apparatus for carrying out such production even though the disclosed methods are not limited thereto.

Commercial batch mixtures used for ceramic honeycomb production are largely composed of mixtures of oxides or oxide precursors that can be converted to refractory ceramics such as cordierite and aluminum titanate during the firing (e.g., sintering or reactive sintering) stage of manufacture. Ceramic batch mixtures comprising two or more oxides or precursors of oxides selected from the group consisting of aluminum oxide, titanium dioxide, silicon dioxide, magnesium oxide, and graphite are typical of the mixtures presently used to manufacture the porous honeycombs needed for ceramic wall flow filter fabrication.

As one example, the production of porous ceramic honeycombs comprising a principal crystalline phase of aluminum titanate involves the use of plasticized batch mixtures consisting predominantly (i.e, containing more than 50% total by weight) of titanium dioxide and aluminum oxide. Graphitic carbon is frequently an added optional component of such mixtures that helps to develop the controlled wall porosity required to secure efficient particle filtration by the filters.

The finding that alumina and graphite particle sizes and size distributions play a large role in inducing shrinkage variability in porous aluminum titanate honeycombs for wall flow filtration comprises an important aspect of the present disclosure. Significant changes in the median particle sizes (D₅₀) of alumina and/or graphite raw materials have been linked to subsequent high rates of change in firing shrinkage, the latter causing a decrease in product selection rates due to the honeycombs being either too large or too small to meet size specifications after firing. Uncontrolled particle size changes in these raw materials have also been found to have a significant impact on median pore diameter and modulus of rupture strength in the fired honeycombs.

FIG. 1 of the drawings is a graph illustrating the effects of variations in the median particle size of one alumina component of a typical aluminum titanate honeycomb batch mixture on the percent shrinkage observed during the conversion of sections of dried alumina-containing honeycomb extrudate to fired aluminum titanate honeycombs. The variations tracked in the drawing cover a multiple-day period of honeycomb extrusion, as indicated in hours [T (hr)] on the horizontal axis of the graph.

The right-hand vertical axis of the graph, labeled [D₅₀ (μm)] in the drawing, reflects the range of median particle sizes, as measured in micrometers, for an A-10 alpha aluminum oxide batch constituent incorporated into the batch over the duration of the continuous extrusion run. The measured particle sizes are indicated by the data points connected by the broken line in the graph.

The left-hand vertical axis in FIG. 1 provides a percent shrinkage scale [S (%)] for the firing shrinkages measured on the fired honeycombs, as indicated by the data points connected by the solid line in the graph. The high shrinkage variability resulting from relatively small changes in the median particle size of this particular alumina batch constituent is evident from the drawing, and is the cause of significant production losses from out-of-tolerance fired ware.

The methods and apparatus provided in accordance with the present disclosure are generally applicable to the manufacture of aluminum titanate and other ceramic honeycomb bodies by the known steps of batch preparation, extrusion, drying, and firing. As conventionally practiced, a plasticized ceramic powder batch comprising a liquid vehicle and a mixture of powdered oxides or oxide precursors such as described above is compounded, the batch is formed into green honeycomb extrudate by continuous extrusion, and the extrudate is dried and fired to produce a ceramic honeycomb body.

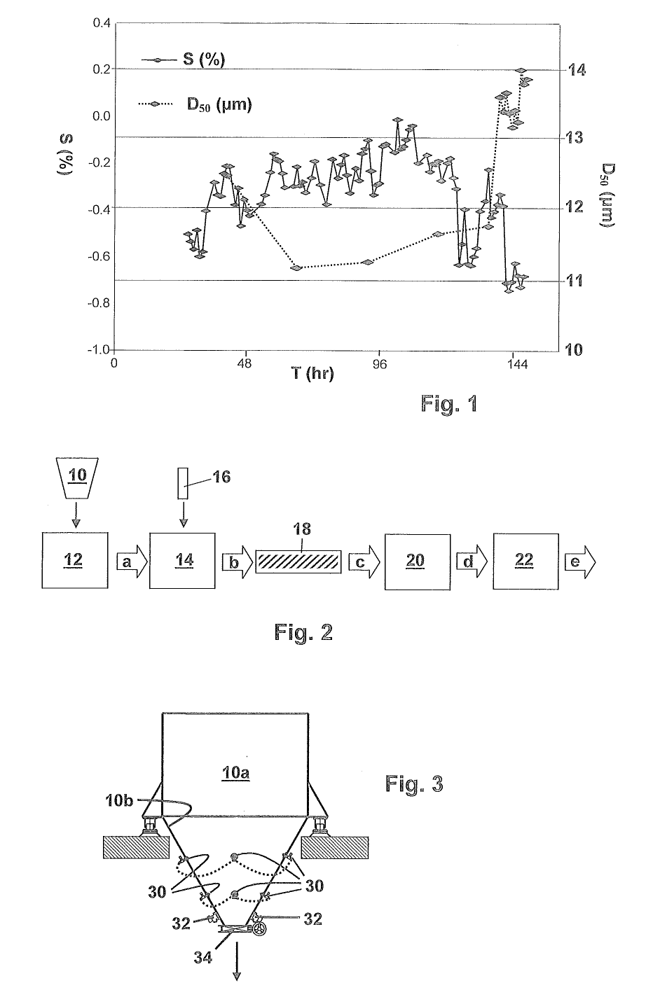

FIG. 2 of the drawing is flow diagram outlining the conventional processing steps and equipment typically used for the manufacture of ceramic honeycomb bodies in accordance with prior practice. As shown in FIG. 2, the dry constituents of a ceramic powder batch supplied from powder reservoirs such as powder reservoir 10 are released into a dry blender 12 and processed to provide a well blended powder mixture. The resulting dry-blended powder mixture (a) is then introduced into a wet mixer 14 where liquid constituents for the vehicle component of the batch, including for example water from water supply 16, are added to the powder mixture with blending to produce a wet batch mixture.

The wet mixture (b) from mixer 14 is then fed to an extruder such as screw extruder 18 for further mixing and plasticization, then being continuously discharged from extruder 18 as wet honeycomb extrudate (c). The wet extrudate is then sectioned, introduced into dryer 20 for drying to produce dried extrudate or preform sections. The dried sections (d) are then stacked in a kiln 22 and fired to produce fired ceramic honeycombs (e).

The methods and apparatus provided in accordance with the present disclosure operate to reduce the short term variability reflected in FIG. 1 of the drawings, as well as other variations in honeycomb properties, none of which are effectively addressed in the conventional practice of honeycomb manufacture in accordance with FIG. 2. The necessary reductions are achieved though modifications in the way that the powdered constituents of the batch, such as alumina and graphite, are introduced into the manufacturing process.

Particular embodiments of the disclosed methods and apparatus involve the in-line mechanical homogenization of one or more of the powdered batch constituents responsible for large shrinkage variability. That homogenization generally involves the use of one or a combination of localized powder blending and vibration-assisted powder delivery to achieve the required median particle size stability. More generally, the required results are achieved by methods wherein the step of compounding the plasticized powder batch includes a step of delivering at least one powder of reduced median particle size variability to a mixer for incorporation into the ceramic batch mixture, and wherein delivering comprises conveying a mechanically homogenized feed of the at least one powder from a bulk powder reservoir to the mixer. The reduced variability thus achieved is such that the at least one powder, e.g., a powder selected from the group consisting of aluminum oxide and graphite, has a median particle size D₅₀ that varies from a maximum value to a minimum value by an amount not exceeding 15%, or in some embodiments not exceeding 10%, of the maximum value of median particle size for those powders processed during a 24-hour period of continuous extrusion.

In particular embodiments of the thus-modified methods the mechanical homogenization of the at least one powder is carried out by powder agitation within the bulk powder reservoir. Examples include methods wherein powder agitation is accomplished by at least one of reservoir vibration and pneumatic powder blending. Those modes of mechanical homogenization operate to reduce powder particle size segregation due, for example, to particle agglomeration in the as-delivered powder or particle size fractionation occurring during the discharge of non-homogenized powder charges from the reservoir. Particle size fractionation is thought to be the consequence of a frequently observed uneven gravitational powder feed from the reservoir, sometimes referred to as “rat-holing”. Fast feeds of some powder size fractions occur while other size fractions are slowed, for example, by the selective sticking of those particle size fractions to reservoir walls.

In embodiments of the presently disclosed methods wherein the selected powder is, for example, aluminum oxide or graphite, the levels of particle size variability in the mechanically homogenized powder are sufficiently reduced that the median particle size (D₅₀) of the selected powder varies from a maximum value to a minimum value by an amount not exceeding 15% of the maximum value during a selected 24-hour period of in-line homogenization and continuous extrusion of the thus-homogenized honeycomb batch.

In manufacturing systems such as above disclosed that utilize a bulk powder reservoir incorporating means for homogenizing a feed of a dry aluminum oxide or graphite powder prior to delivery of the powder to a dry powder blender, particular embodiments of the means for homogenizing comprise at least one of reservoir vibrating means and pneumatic powder blending means. The means to be selected are effective to limit variations in the median particle size (D₅₀) of the dry powder to a range wherein D₅₀ varies from a maximum value to a minimum value by an amount not exceeding 15%, or in some embodiments not more than 10%, of the maximum value for the powder during a 24-hour period of delivery.

An illustrative example of apparatus useful for achieving the necessary median particle size variability reductions is schematically shown in FIG. 3 of the drawings. FIG. 3 consists of a diagram of a modified bulk powder reservoir 10a, not in true proportion or to scale, which in accordance with the present disclosure is suitably substituted for reservoir 10 in the manufacturing system shown in FIG. 2 of the drawings. As shown in FIG. 3, that reservoir, sometimes referred to as a “day bin”, includes two arrays of mechanical vibration pads 30 attached to the sides of the discharge cone 10b of the bin. Also included in the modified reservoir design is a pair of pneumatic blender heads 32 for agitating portions of a charge of powder contained in cone 10b of the bin.

Vibration pads 30 in FIG. 3 significantly reduce the tendency of powders stored in the bin to stick to the sides of discharge cone 10b during discharge from bin disharge port 34, enabling uniformly smooth mass flow powder transport from the bin to minimize any tendency toward non-uniform powder delivery that could result in particle size fractionation during discharge. Pneumatic powder blender heads 32 also assist in the prevention of non-uniform powder delivery, but more importantly act to blend powder charge segments awaiting discharge, reducing particle size variations resulting, for example, from the sequential charging of the bin with powder lots of differing median particle size.

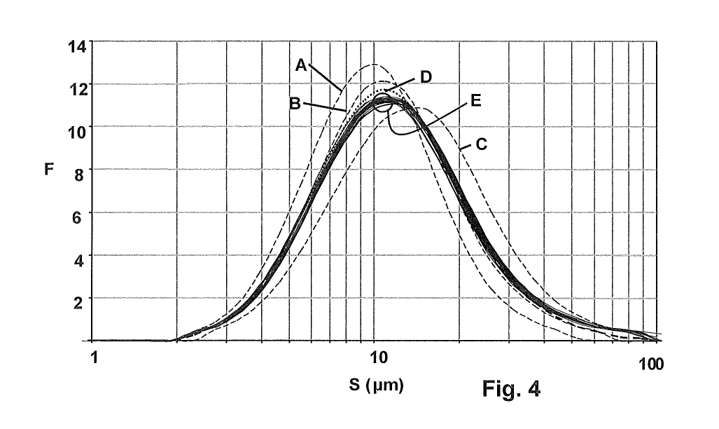

The use of the presently disclosed methods and apparatus can substantially reduce the median particle size variability that is inherently present in raw materials such as alumina and graphite that are delivered to ceramics manufacturers in bags or lots of differing particle sizes and particle size distributions. FIG. 4 of the drawings presents particle size distribution curves for three different lots of a commercial aluminum oxide powder, those curves corresponding to the dashed line curves labeled A, B and C in the drawing. Also plotted in FIG. 4 is a dashed line curve D corresponding to the numerical average of the particle size distributions shown by curves A, B and C. The vertical axis of the graph in FIG. 4 indicates the relative frequencies F for each of the particles sizes measured for the powdered samples, those sizes being reported in micrometers on the horizontal axis [S (μm)] of the graph.

The set of solid line curves labeled E in FIG. 4 consists of curves showing the particle size distributions for a number of alumina powder samples discharged from a modified day bin such as shown in FIG. 3 of the drawings. The data is for a bin charged with the three lots of commercial alumina powder characterized by curves A, B and C in FIG. 4. The samples characterized by the solid line curves were discharged at spaced intervals during an extended period of powder charge homogenization in accordance with the methods of the present disclosure. As is evident from the collected particle size distributions plotted in FIG. 4, the distributions measured for the homogenized powder samples depart markedly from each the commercial powder lot distributions, more closely approaching the computed numerical average particle size distribution of curve D of the drawing.

The extent of agreement among the curves for the in-line-homogenized powder samples, and between those curves and the mathematical average curve for the three different powder lots, confirms the effectiveness of the disclosed methods and apparatus for minimizing short term variations in ceramic powder particle sizes and corresponding variations in fired ceramic honeycomb shrinkage. Had the three powder lots characterized in FIG. 4 instead been randomly introduced into a conventional honeycomb manufacturing process, the resulting fluctuations in median particle size would have caused high rates of change in fired honeycomb shrinkage, with a correspondingly high percentage of out-of-tolerance fired ware.

Statistical studies of the effects of variations in the median particle sizes of commercially available alumina and graphite powders on the properties of fired aluminum titanate honeycombs confirm linkages between those particle sizes and the pore sizes and modulus of rupture strengths of the fired honeycombs that are similar to the linkage between particle size and firing shrinkage. Thus the presently disclosed methods and apparatus additionally offer important benefits for the control of variations in pore size and strength that could otherwise result in production losses due to failures to meet honeycomb pore size and strength specifications.

The advantages secured through the use of the disclosed methods and apparatus thus include reductions in day-to-day variations in fired honeycomb shrinkage, pore size and strength that enable honeycomb size, porosity and strength targets to more consistently be met. The percentages of manufactured ware failing to meet those targets are thereby reduced, as is the need to employ alternative process control measures to overcome unexpectedly rapid changes in honeycomb properties or even related problems of plasticized batch rheology. Finally, the disclosed methods enable the use of purchased lots of powdered batch constituents that would otherwise be rejected as out-of-specification for particle size and particle size distribution. The economic benefits of the presently disclosed methods and apparatus are therefore evident.

Of course the particular embodiments of methods and apparatus set forth above are offered for the purpose of illustration only, it being apparent from the foregoing descriptions that numerous variations and modifications of the disclosed methods and apparatus may be developed in support of related applications in the field of ceramic products manufacture within the scope of the appended claims.

What is claimed is:

1. A method for manufacturing a ceramic honeycomb body comprising the steps of:
compounding a plasticized ceramic batch mixture comprising a liquid vehicle and a mixture of powdered oxides or oxide precursors, forming the batch material into green honeycomb extrudate by continuous extrusion, and drying and firing the extrudate to produce a ceramic honeycomb body, wherein:
the step of compounding includes a step of delivering at least one powder selected from the group consisting of aluminum oxide and graphite to a mixer for incorporation into the ceramic batch mixture, and wherein the at least one powder has a median particle size D₅₀ that varies from a maximum value to a minimum value by an amount not exceeding 15% of the maximum value during a 24-hour period of continuous extrusion.

2. The method of claim 1 wherein the ceramic batch mixture comprises two or more oxides or precursors of oxides selected from the group consisting of aluminum oxide, titanium dioxide, silicon dioxide, magnesium oxide, and graphite.

3. The method of claim 2 wherein the batch material consists predominantly of titanium oxide and aluminum oxide, and wherein the honeycomb body comprises a principal crystalline phase of aluminum titanate.

4. The method of claim 1 wherein the step of delivering comprises conveying a mechanically homogenized feed of the at least one powder from a bulk powder reservoir to the mixer.

5. The method of claim 4 wherein a mechanical homogenization of the at least one powder is carried out by powder agitation within the bulk powder reservoir.

6. The method of claim 5 wherein powder agitation is accomplished by at least one of reservoir vibration and pneumatic powder blending.

7. The method of claim 5 wherein the mechanical homogenization is sufficient to reduce powder particle size segregation due to powder agglomeration and particle size fractionation during powder discharge from the bulk powder reservoir.

8. The method of claim 1 wherein the at least one powder is aluminum oxide, and wherein the powder has a median particle size D₅₀ that varies from a maximum value to a minimum value by an amount not exceeding 10% of the maximum value during a 24-hour period of continuous extrusion.

9. A process for making a ceramic honeycomb from a continuous feed of plasticized honeycomb batch material, the batch material comprising a powder mixture of honeycomb precursors including at least one powder selected from the group of aluminum oxide and graphite powders, wherein the median particle size D₅₀ of the at least one powder varies from a maximum value to a minimum value by an amount not exceeding 15% of the maximum value during a 24-hour interval of continuous feed.

10. A system for manufacturing ceramic honeycombs comprising a dry powder blender, a wet batch mixer downstream of the blender, and a continuous extruder downstream of the wet mixer for plasticizing and conveying a plasticized wet mixture of ceramic precursor powders and a vehicle through a honeycomb extrusion die, wherein
at least one dry powder selected from the group of aluminum oxide and graphite is delivered to the dry powder blender from a bulk powder reservoir, and wherein
the bulk powder reservoir incorporates means for homogenizing a feed of the at least one dry powder prior to delivery of the feed to the dry powder blender.

11. The system of claim 10 wherein the means for homogenizing comprises at least one of reservoir vibrating means and pneumatic powder blending means.

12. The system of claim 10 wherein the means for homogenizing is effective to limit a variation in a median particle size D₅₀ of the at least one powder to a range wherein D₅₀ varies from a maximum value to a minimum value by an amount not exceeding 15% of the maximum value during a 24-hour period of delivery.
